(19) United States
(12) Patent Application Publication
(10) Pub. No.: US 2026/0062264 A1
(43) Pub. Date: Mar. 5, 2026

(54) Jack

(71) Applicant: Qingdao Zhaorun auto parts Co., LTD, Qingdao (CN)

(72) Inventor: Zhaorun SUN, Qingdao (CN)

(21) Appl. No.: 18/899,762

(22) Filed: Sep. 27, 2024

(30) Foreign Application Priority Data
Sep. 4, 2024 (CN) 2024221609733

(51) Int. Cl. B66F 3/12

(52) U.S. Cl. CPC B66F 3/12

(57) ABSTRACT

The present disclosure discloses a jack including a first upper arm, a second upper arm, a first lower arm, a second lower arm and a first rod body, which is characterized in that it is further provided with a first pin shaft—the first upper arm and the first lower arm are rotatably connected by the first pin shaft; a second pin shaft—the second pin shaft has an internal chamber, the second upper arm and second lower arm are rotatably connected by the second pin shaft, and the first rod body is rotatably connected to the second pin shaft; a locking component—the locking component is set in the second pin shaft and can be connected to the first rod body through threads or sliding; the beneficial effects of the present disclosure are: using the present disclosure can ensure the stability of a recreational vehicle (RV).

### CROSS-REFERENCE TO RELATED APPLICATION

This application claims priority from the Chinese patent application 2024221609733 filed Sep. 4, 2024, the content of which is incorporated herein in the entirety by reference.

### TECHNICAL FIELD

The present disclosure relates to the field of jack technology and particularly to a jack.

### BACKGROUND

Jacks are commonly used tools for vehicle maintenance or supporting RVs to ensure stability. However, for a user, adjusting the height of a jack may be a hard work since he/she has to continuously adjust the height. The operation is a time-consuming and labor-intensive process, and therefore in order to solve this issue, a jack is proposed.

### SUMMARY

The present disclosure is intended to provide a jack to solve the issue shown in the background technology mentioned above.

To achieve the above purpose, the present disclosure provides the following technical solutions:
A jack comprising a first upper arm, a second upper arm, a first lower arm, a second lower arm and a first rod body, which is characterized in that it is further provided with:
A first pin shaft—the first upper arm and first lower arm are rotatably connected by the first pin shaft;
A second pin shaft—the second pin shaft has an internal chamber, the second upper arm and second lower arm are rotatably connected by the second pin shaft, and the first rod body is rotatably connected to the second pin shaft;
A locking component—the locking component is set in the second pin shaft and can be connected to the first rod body through threads or sliding;

Preferably, a base is included, the base is rotatably connected to the first and second lower arm.

Preferably, a second rod body is included, which is rotatably connected to the first pin shaft and second pin shaft, and the locking component can be connected to the second rod body in a contact manner.

Preferably, the locking component has a first locking part and a second locking part; the first rod body is set between the first locking part and second locking part, and the ends of the first and second locking parts near the first rod body have threads matching with those of the first rod body.

Preferably, the first locking part is locked or fixedly connected to the second pin shaft, and the second locking part is locked to the second pin shaft.

Preferably, the cross-section of the second locking part is hexagonal, the cross-section of the chamber is hexagonal, and the outer wall of the second locking part fits the inner wall of the chamber.

Preferably, the cross-section of the second locking part is quadrilateral, the cross-section of the chamber is quadrilateral, and the outer wall of the second locking part fits the inner wall of the chamber.

Preferably, the second rod body has a first groove body, the length direction of the first groove body is the same as the axial direction of the second rod body, and part of the second locking part can be in the first groove body;

When part of the second locking part is in the first groove body, the locking component is connected to the first rod body through sliding; when part of the second locking part is not in the first groove body, the locking component is connected to the first rod body through threads.

Preferably, the end of the second locking part away from the first rod body can be in the first groove body.

When the end of the second locking part away from the first rod body is in the first groove body, the locking component is connected to the first rod body through sliding; when part of the second locking part is not in the first groove body, the locking component is connected to the first rod body through threads.

When the end of the second locking part away from the first rod body is in the first groove body, the locking component is connected to the first rod body through sliding; when the end of the second locking part away from the first rod body is not in the first groove body, the locking component is connected to the first rod body through threads.

Preferably, the locking component has a first elastic body and a second elastic body, the end of the second locking part near the first rod body has a second groove body, and the first elastic body is set in the second groove body; the end of the first locking part near the first rod body has a fourth groove body, and the second elastic body is set in the fourth groove body;

When the first rod body is connected to the second pin shaft through threads, both the first and second elastic bodies are compressed, and one end of the first elastic body is jointed with the first rod body, the other end is jointed with the bottom of the second groove body; one end of the second elastic body is jointed with the first rod body, and the other end is jointed with the bottom of the fourth groove body.

Preferably, the first elastic body is a spring.

Preferably, the first elastic body comprise a spring, and one end of the spring is fixedly connected to a block.

Preferably, the second elastic body is a spring.

Preferably, the second elastic body comprise a spring, and one end of the spring is fixedly connected to a block.

Preferably, the first pin shaft has a first through-hole, the second pin shaft has a second through-hole, and the second rod body passes through both the first and second through-holes.

Preferably, the jack is further provided with a lockup component for locking up the rotation of the second rod body; the lockup component has a positioner, a resister and a compressed spring; the positioner is connected to the second rod body through threads, and the resister is locked to the second rod body;

The first pin shaft has a third groove body, and the positioner is set in the third groove body and is locked to the third groove body through a spring;

The second rod passes through a spring, and the spring is set between the second pin shaft and resister.

Preferably, the second rod body has a positioner threaded hole and a resister through-hole, the positioner is connected to the threaded hole through threads, and the resister passes through the resister through-hole and is locked to it.

Preferably, the jack is further provided with a jack-up head and a fitting body; the first and second upper arms are both rotatably connected to the jack-up head, and the fitting body is fixedly connected to the jack-up head.

Preferably, a gasket is placed between the second pin shaft and spring.

The first rod body is fixedly connected with a handle and a stopper; the handle is set at the end of the first rod body near the first pin shaft, and the first pin shaft is set between the handle and stopper. A gasket is placed between the handle and first pin shaft, and a gasket is placed between the stopper and first pin shaft.

The present disclosure is designed with a locking component for ensuring a sliding connection and a threaded connection between the first rod body and second pin shaft, this technical feature can help to achieve quick contraction and extension.

The locking component of the present disclosure is designed with a first locking part and a second locking part; the first and second locking parts are fit to the first rod body through threads, and the second locking part has a first elastic body; the first locking part has a second elastic body, and the second rod body has a groove; The design series can make the jack to be conveniently contracted and extended.

The present disclosure is designed with a lockup component to ensure that the second rod body cannot rotate freely, further stabilizing the quick extension and contraction mentioned in the art.

The second locking part and second pin shaft of the present disclosure are locked to ensure the relative stability of the second locking part and second pin shaft, further ensuring the fixation and continuity for quick extension and contraction mentioned in the art.

Compared with the prior art, the beneficial effects of the present disclosure are: using the present disclosure can ensure the stability of a recreational vehicle (RV), reduce vibration caused by tire elasticity for a more comfortable purpose; when not in use, the jack can be quickly contracted, saving time and reducing labor intensity. In addition, this jack can be directly fixed under the vehicle body, making it convenient to carry and saving space.

### DESCRIPTION OF THE DRAWINGS

FIG. 1 shows a 3D structure diagram of the present disclosure;

FIG. 2 shows a sectional structure diagram of the present disclosure;

FIG. 3 shows a structure diagram at point A in FIG. 2 of the present disclosure;

FIG. 4 shows a structure diagram at point B in FIG. 2 of the present disclosure;

FIG. 5 shows a structure diagram of the second rod body of the present disclosure;

FIG. 6 shows a 3D structure diagram of the second pin shaft of the present disclosure;

FIG. 7 shows a 3D structure diagram of the second locking part matching FIG. 6;

FIG. 8 shows a 3D structure diagram of the first locking part matching FIG. 6;

FIG. 9 shows another 3D structure diagram of the second pin shaft of the present disclosure;

FIG. 10 shows a 3D structure diagram of the second locking part matching FIG. 9;

FIG. 11 shows a 3D structure diagram of the first locking part matching FIG. 9;

FIG. 12 shows a 3D structure diagram of the first pin shaft;

In the figures: 11—First upper arm; 12—Second upper arm; 13—First lower arm; 14—Second lower arm; 15—Jack—up head; 16—Fitting body; 17—Base; 2—First rod body; 21—Handle; 3—First pin shaft; 31—First through—hole; 32—Third groove body; 4—Second pin shaft; 41—Second through—hole; 5—Locking component; 51—First locking part; 52—Second locking part; 53—First elastic body; 54—Second groove body; 55—Fourth groove body; 56—Second elastic body; 6—Second rod body; 61—First groove body; 62—Threaded hole; 63—Resister through—hole; 7—Lockup component; 71—Positioner; 72—Resister; 73 Spring; 8—Gasket; 9—Stopper.

### DETAILED DESCRIPTION OF THE EMBODIMENTS

Based on the drawings involved in the embodiments of the present disclosure, the following will provide a clear and complete description of the technical solutions in the embodiments of the present disclosure. Obviously, the described items are only a part of the embodiments of the disclosure. Based on the embodiments of the present disclosure, all other embodiments obtained by common technicians in the art without making creative labor shall fall within the protection of the present disclosure.

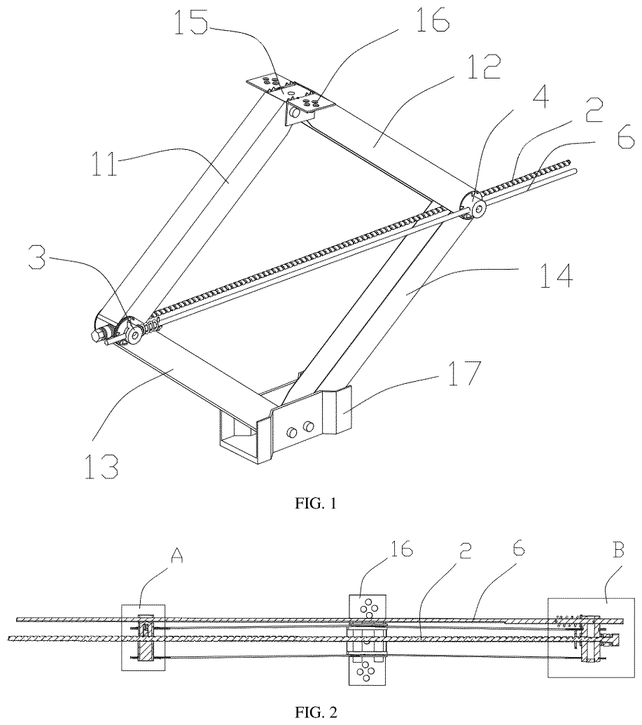

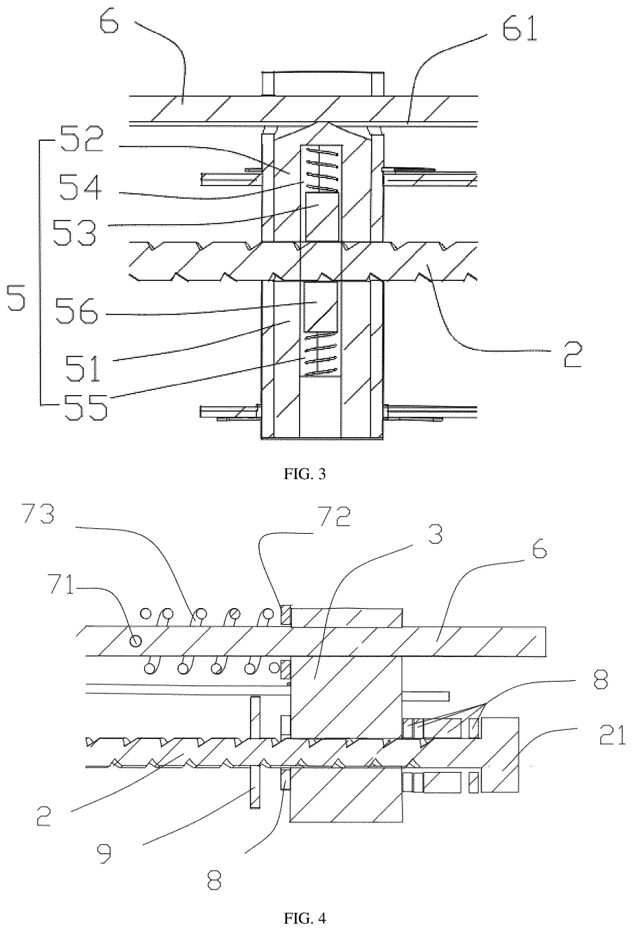

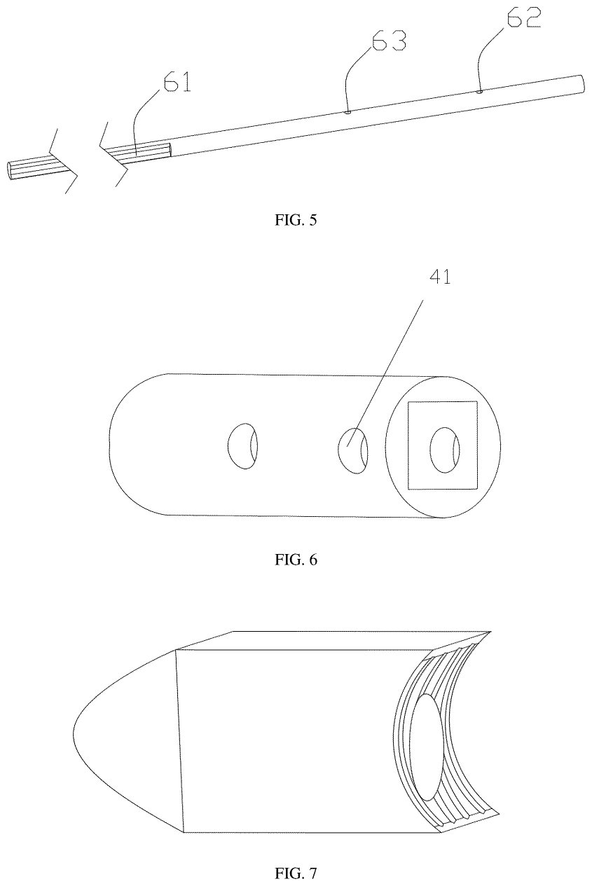

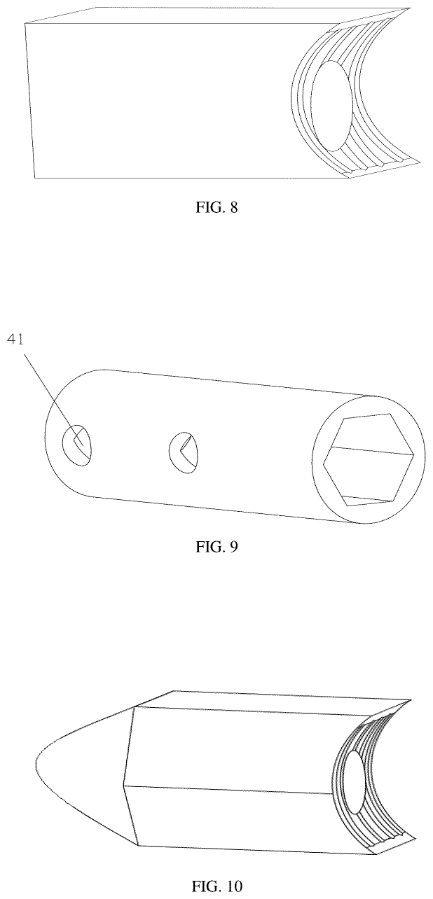

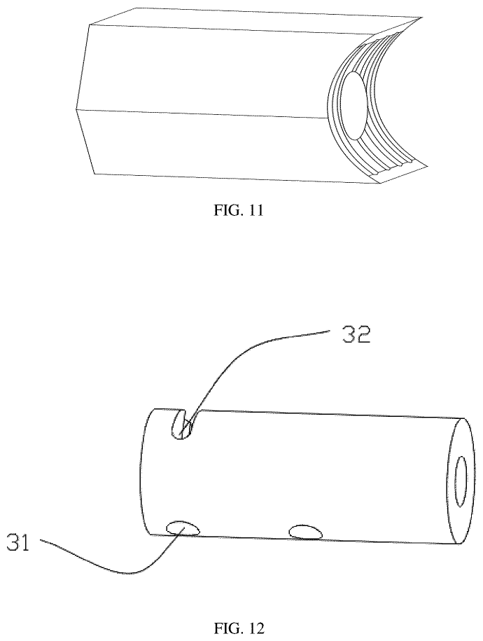

According to FIGS. 1-9, the present disclosure provides the following technical solutions:

### Embodiment 1

A jack comprising a first upper arm 11, a second upper arm 12, a first lower arm 13, a second lower arm 14 and a first rod body 2, which is characterized in that it is further provided with:
A first pin shaft 3—the first upper arm 11 and first lower arm 13 are rotatably connected by the first pin shaft 3;
A second pin shaft 4—the second pin shaft 4 has an internal chamber, the second upper arm 12 and second lower arm 14 are rotatably connected by the second pin shaft 4, and the first rod body 2 is rotatably connected to the second pin shaft 4;
A locking component 5—the locking component 5 is set in the second pin shaft 4 and can be connected to the first rod body 2 through threads or to the first rod body 2 through sliding.

A base is included, the base is rotatably connected to the first lower arm 13 and second lower arm 14.

A second rod body 6 is included, the second rod body 6 is rotatably connected to the first pin shaft 3 and second pin shaft 4, and the locking component 5 can be connected to the second rod body 6 in a contact manner.

The locking component 5 has a first locking part 51 and a second locking part 52; the first rod body 2 is set between the first locking part 51 and second locking part 52, and the ends of the first locking part 51 and second locking part 52 near the first rod body 2 have threads matching with those of the first rod body 2.

The first locking part 51 is locked or fixedly connected to the second pin shaft 4, and the second locking part 52 is locked to the second pin shaft 4.

The cross-section of the second locking part 52 is hexagonal, the cross-section of the chamber is hexagonal, and the outer wall of the second locking part 52 fits the inner wall of the chamber.

The second rod body 6 has a first groove body 61, the length direction of the first groove body 61 is the same as the axial direction of the second rod body 6, and the end of part of the second locking part 52 away from the first rod body 2 can be in the first groove body 61;

When part of the second locking part 52 is in the first groove body 61, the locking component 5 is connected to the first rod body 2 through sliding; when part of the second locking part 52 is not in the first groove body 61, the locking component 5 is connected to the first rod body 2 through threads.

The end of the second locking part 52 away from the first rod body 2 can be in the first groove body 61.

When the end of the second locking part 52 away from the first rod body 2 is in the first groove body 61, the locking component 5 is connected to the first rod body 2 through sliding; when part of the second locking part 52 is not in the first groove body 61, the locking component 5 is connected to the first rod body 2 through threads.

The locking component 5 has a first elastic body 53 and a second elastic body 56, the end of the second locking part 52 near the first rod body 2 has a second groove body 54, and the first elastic body 53 is set in the second groove body 54; the end of the first locking part near the first rod body has a fourth groove body, and the second elastic body is set in the fourth groove body; When the first rod body 2 is connected to the second pin shaft 4 through threads, both the first elastic body 53 and second elastic body 56 are compressed, and one end of the first elastic body 53 is jointed with the first rod body 2, the other end is jointed with the bottom of the second groove body 54; one end of the second elastic body 56 is jointed with the first rod body 2, and the other end is jointed with the bottom of the fourth groove body 55.

The first pin shaft 3 has a first through-hole 31, the second pin shaft 4 has a second through-hole 41, and the second rod body 6 passes through both the first through-hole 31 and second through-hole 41.

The jack is further provided with a lockup component 7 for locking up the rotation of the second rod body 6; the lockup component 7 has a positioner 71, a resister 72 and a compressed spring 73; the positioner 71 is connected to the second rod body 6 through threads, and the resister 72 is locked to the second rod body 6;

The first pin shaft 3 has a third groove body 32, and the positioner 71 is set in the third groove body 32 and is locked to the third groove body 32 through a spring 73;

The second rod 6 passes through a spring 73, and the spring 73 is set between the second pin shaft 4 and resister 72.

The second rod body 6 has a positioner 71 threaded hole and a resister 72 through-hole, the positioner 71 is connected to the threaded hole through threads, and the resister 72 passes through the resister 72 through-hole and is locked to it.

the jack is further provided with a jack-up head 15 and a fitting body 16; the first upper arm 11 and second upper arm 12 are both rotatably connected to the jack-up head 15, and the fitting body 16 is fixedly connected to the jack-up head 15.

The first rod body 2 is fixedly connected with a handle and a stopper; the handle is set at the end of the first rod body 2 near the first pin shaft 3, and the first pin shaft 3 is set between the handle and stopper. A gasket is placed between the handle and first pin shaft 3, and a gasket is placed between the stopper and first pin shaft 3.

### Embodiment 2

The cross-section of the second locking part 52 is quadrilateral, the cross-section of the chamber is quadrilateral, and the outer wall of the second locking part 52 fits the inner wall of the chamber; a gasket is placed between the second pin shaft 4 and spring 73, and the first locking part 51 is fixedly connected to the second pin shaft 4.

The remaining technical solutions are the same as the embodiments.

### Working Principle and Operation Process of the Present Disclosure:

Install this disclosure under a vehicle from fitting body 16. When an extension of the jack is needed, hold the positioner 71, take it out from the third groove body 32, and rotate the second rod 6; apply a force to the second locking part 52 through the first elastic body 53 to make the top of the second locking part 52 enter into the first groove body 61; when the first elastic body 54 and second elastic body 56 release their elastic force, the first rod body 2 can be connected to the locking component 5 through sliding, and the base of the jack can descend freely; when the base is in contact with the ground, hold the positioner 71 again and take it out from the third groove body 32, and rotate the second rod body 6 to make the top of the second locking part 52 face away from the first groove body 61; when the elastic members are compressed, the first rod body 2 can be connected to the locking component 5 through threads, hold the handle and turn the first rod body 2 to extend the jack.

When a contraction of the jack is needed, hold the positioner 71 and take it out from the third groove body 32, rotate the second rod body 6 to make the top of the second locking part 52 enter into the first groove body 61; push the base towards the vehicle to select an appropriate position, then hold the positioner 71 and take it out from the third groove body 32, rotate the second rod body 6 to make the top of the second locking part 52 face away from the first groove body 61; hold the handle and turn the first rod body 2 until the jack is compressed to an appropriate level.

Although the embodiments of the present disclosure have been shown and described (see the above details), for those skilled in the art, it can be understood that changes, modifications, substitutions and variations can be made to these embodiments within the principles and spirit of the present disclosure. The scope of the present disclosure is limited by the claims and their equivalents.

In the description of this application, it should be noted that terms such as “center”, “up”, “down”, “left”, “right”, “vertical”, “horizontal”, “inside”, “outside” indicate directions or positional relationships based on the directions or positional relationships shown in the drawings, which are only intended to easily and briefly describe the present disclosure rather than indicate or imply that a device or element must be set, constructed and operated in a specified direction, and therefore shall not be understood as limit to the present disclosure. In addition, the terms “first”, “second” and “third” are only used for descriptive purposes and cannot be understood as indicating or implying a relative importance.

In the description of this application, it should be noted that unless otherwise specified and limited, the terms “install”, “connect” and “joint” should be broadly understood, for example, they can be fixed, detachable or integral connections, mechanical or electrical connections, direct connections, or indirect connections achieved through intermediate media, or internal connections between two components. For common technicians in the art, the specific meanings of these terms in this application can be understood depending on the specific circumstances.

1. A jack comprising a first upper arm (11), a second upper arm (12), a first lower arm (13), a second lower arm (14) and a first rod body (2), wherein it is further provided with:
a first pin shaft (3)—the first upper arm (11) and first lower arm (13) are rotatably connected by the first pin shaft (3);
a second pin shaft (4)—the second pin shaft (4) has an internal chamber, the second upper arm (12) and second lower arm (14) are rotatably connected by the second pin shaft (4), and the first rod body (2) is rotatably connected to the second pin shaft (4);
a locking component (5)—the locking component (5) is set in the second pin shaft (4) and can be connected to the first rod body (2) through threads or to the first rod body (2) through sliding.

2. The jack according to claim 1, wherein it has a rod body (6), the second rod body (6) is rotatably connected to the first pin shaft (3) and second pin shaft (4), and the locking component (5) can be connected to the second rod body (6) in a contact manner.

3. The jack according to claim 1, wherein the locking component (5) has a first locking part (51) and a second locking part (52); the first rod body (2) is set between the first locking part (51) and second locking part (52), and the ends of the first locking part (51) and second locking part (52) near the first rod body (2) have threads matching with those of the first rod body (2).

4. The jack according to claim 3, wherein the first locking part (51) is locked or fixedly connected to the second pin shaft (4), and the second locking part (52) is locked to the second pin shaft

5. The jack according to claim 3, wherein the second rod body (6) has a first groove body (61), the length direction of the first groove body (61) is the same as the axial direction of the second rod body (6), and part of the second locking part (52) can be in the first groove body (61);
when part of the second locking part (52) is in the first groove body (61), the locking component (5) can be connected to the first rod (2) through sliding; when the second locking part (52) is not in the first groove body (61), the locking component (5) can be connected to the first rod body (2) through threads.

6. The jack according to claim 3, wherein the locking component (5) has a first elastic body (53) and a second elastic body (56), the end of the second locking part (52) near the first rod body (2) has a second groove body (54), and the first elastic body (53) is set in the second groove body (54); the end of the first locking part (51) near the first rod body (2) has a fourth groove body (55), and the second elastic body (56) is set in the fourth groove body (55);
when the first rod body (2) is connected to the second pin shaft through threads, both the first elastic body (53) and second elastic body are compressed, and one end of the first elastic body (53) is jointed with the first rod body (2), the other end is jointed with the bottom of the second groove body (54); one end of the second elastic body (56) is jointed with the first rod body (2), and the other end is jointed with the bottom of the fourth groove body (55).

7. The jack according to claim 2, wherein the first pin shaft (3) has a first through hole (31), the second pin shaft (4) has a second through hole (41), and the second rod body (6) passes through the first through hole (31) and second through hole (41).

8. The jack according to claim 2, wherein the jack is further provided with a lockup component (7) for locking up the rotation of the second rod body (6); the lockup component (7) has a positioner (71), a resister (72) and a compressed spring (73); the positioner (71) is connected to the second rod body (6) through threads, and the resister (72) is locked to the second rod body (6);
the first pin shaft (3) has a third groove body (32), and the positioner (71) is set in the third groove body (32) and is locked to the third groove body (32) through a spring (73);
the second rod body (6) passes through the spring (73), and the spring (73) is set between the second pin shaft (4) and resister (72).

9. The jack according to claim 1, wherein the jack is further provided with a jack-up head (15) and a fitting body (16); the first upper arm (11) and second upper arm (12) are both rotatably connected to the jack-up head (15), and the fitting body (16) is fixedly connected to the jack-up head (15).

10. The jack according to claim 3, wherein the second rod body (6) has a first groove body (61), the length direction of the first groove body (61) is the same as the axial direction of the second rod body (6), and part of the second locking part (52) can be in the first groove body (61);
when part of the second locking part (52) is in the first groove body (61), the locking component (5) can be connected to the first rod (2) through sliding; when the second locking part (52) is not in the first groove body (61), the locking component (5) can be connected to the first rod body (2) through threads.
